(19) United States
(12) Patent Application Publication
(10) Pub. No.: US 2013/0320117 A1
(43) Pub. Date: Dec. 5, 2013

(54) ELECTROSTATIC ATOMIZER DEVICE AND METHOD FOR PRODUCING SAME

(71) Applicant: Kentaro Kobayashi, Hyogo (JP)

(72) Inventor: Kentaro Kobayashi, Hyogo (JP)

(73) Assignee: PANASONIC CORPORATION, Osaka (JP)

(21) Appl. No.: 14/000,117

(22) PCT Filed: Sep. 7, 2011
(86) PCT No.: PCT/JP2011/070373

§ 371 Date: Aug. 16, 2013

(30) Foreign Application Priority Data
Mar. 23, 2011 (JP) 2011-063950

(51) Int. Cl. B05B 5/057; H05F 3/06

(52) U.S. Cl. CPC B05B 5/057; H05F 3/06
USPC 239/690; 427/58

(57) ABSTRACT

An electrostatic atomizer device comprises: a substrate 10; a thin-film N-type pattern 3 formed on the substrate 10, using an N-type thermoelectric material; a thin-film P-type pattern 4 formed on the substrate 10, using a P-type thermoelectric material; and an emitter electrode 6 connected between the N-type pattern 3 and the P-type pattern 4. The N-type pattern 3, the emitter electrode 6 and the P-type pattern 4 form an electrical conductive path for cooling.

### TECHNICAL FIELD

The invention relates generally to electrostatic atomizer devices and methods for producing the same and, more particularly, to an electrostatic atomizer device which generates charged minute water particles and a method for producing the same.

### BACKGROUND ART

An electrostatic atomizer device has been known, which applies a voltage to an emitter electrode that retains water, thereby generating the electrically atomizing phenomenon for the water, and generating charged minute water particles.

As one example of such an electrostatic atomizer device, Japanese patent application publication No. 2006-826 discloses a configuration that cools the emitter electrode, using a Peltier unit to generate condensation water, and generates charged minute water particles, using the condensation water. This electrostatic atomizer device does not need a water tank or the like for supplying water to the emitter electrode, and therefore, the entire device is downsized.

Japanese patent application publication No. 2011-25225 discloses an electrostatic atomizer device in which downsizing and electrical power saving are further enhanced. The electrostatic atomizer device, as shown in FIG. 11, is provided so that current flows between an N-type thermoelectric element 100 and a P-type thermoelectric element 101 through an emitter electrode 102 itself. Therefore, the entire device is further downsized. Also, the electrostatic atomizer device can cool the emitter electrode 102 effectively, and therefore, the electrical power saving is enhanced.

As explained above, the electrostatic atomizer device described in Japanese patent application publication No. 2011-25225 can enhance the downsizing and electrical power saving. The electrostatic atomizer device, however, adopts blockish members cut down from an ingot, as the N-type and P-type thermoelectric elements. For this reason, in the case where the emitter electrode is installed upright, there are limitations to, in particular, downsizing for the upright direction. Therefore, there are also limitations to downsizing for the entire device. Further, in the blockish thermoelectric elements, there are limitations to a reduction in a drive current. Therefore, there are also limitations to the electrical power saving for the entire device.

### DISCLOSURE OF THE INVENTION

It is an object of the present invention to provide an electrostatic atomizer device, which can further enhance downsizing and electrical power saving, and a method for producing the same.

An electrostatic atomizer device of the present invention comprises: a substrate; a thin-film N-type pattern formed on the substrate, using an N-type thermoelectric material; a thin-film P-type pattern formed on the substrate, using a P-type thermoelectric material; and an emitter electrode connected between the N-type pattern and the P-type pattern, and the N-type pattern, the emitter electrode and the P-type pattern forming an electrical conductive path.

Therefore, the electrostatic atomizer device of the present invention has the effect of achieving further downsizing and electrical power saving.

Preferably, the electrostatic atomizer device of the present invention further comprises a thin-film first heat radiation side electrode pattern and a thin-film second heat radiation side electrode pattern, both of which being formed on the substrate, and wherein the first and second heat radiation side electrode patterns are formed so as to be opposed to each other through the N-type pattern, the emitter electrode and the P-type pattern, on the substrate, the first heat radiation side electrode pattern, the N-type pattern, the emitter electrode, the P-type pattern and the second heat radiation side electrode pattern forming the electrical conductive path, the first heat radiation side electrode pattern being formed so as to have a thickness larger than each of the N-type and P-type patterns, the second heat radiation side electrode pattern being formed so as to have a thickness larger than each of the N-type and P-type patterns.

Preferably, the electrostatic atomizer device further comprises an electrical jointing portion that serves as a bridge between the N-type pattern and the P-type pattern, the emitter electrode being joined on the electrical jointing portion.

Preferably, the substrate is formed of a material that has higher heat conductivity than each of the N-type and P-type patterns.

Preferably, the electrostatic atomizer device further comprises a low-heat conduction portion that has lower heat conductivity than the material for the substrate, the low-heat conduction portion being located between the substrate and the emitter electrode.

Preferably, the electrostatic atomizer device further comprises a through portion or a thin-wall portion for preventing heat leakage, the through portion or the thin-wall portion being provided at a part of the substrate adjacent to the emitter electrode.

Preferably, each of the N-type and P-type patterns is formed so that a width thereof diminishes toward a part thereof electrically connected to the emitter electrode.

Preferably, all or part of the electrical conductive path on the substrate is covered with a waterproof coating material.

Preferably, the substrate is formed as a porous body.

Preferably, the electrostatic atomizer device further comprises an opposed electrode that is located at a position opposed to the emitter electrode.

A method for producing an electrostatic atomizer device of the present invention comprises the steps of: forming a thin-film N-type pattern on a substrate, using an N-type thermoelectric material; forming a thin-film P-type pattern on the substrate, using a P-type thermoelectric material; forming an electrical jointing portion that serves as a bridge between the N-type pattern and the P-type pattern; and jointing the emitter electrode on the electrical jointing portion.

Preferably, the method for producing the electrostatic atomizer device of the present invention further comprises a step of forming a thin-film first heat radiation side electrode pattern and a thin-film second heat radiation side electrode pattern so as to be opposed to each other through the N-type pattern, the emitter electrode and the P-type pattern, on the substrate.

### BRIEF DESCRIPTION OF THE DRAWINGS

Preferred embodiments of the invention will now be described in further details. Other features and advantages of the present invention will become better understood with regard to the following detailed description and accompanying drawings where:

FIG. 1 is a schematic side cross section view showing a characterizing portion of an electrostatic atomizer device according to First Embodiment of the invention;

FIG. 2 is a schematic plan view showing the characterizing portion of the electrostatic atomizer device according to the First Embodiment of the invention;

FIG. 3A is a schematic plan view showing a modification of patterning in the electrostatic atomizer device according to the First Embodiment of the invention;

FIG. 3B is a schematic plan view showing a modification of patterning in the electrostatic atomizer device according to the First Embodiment of the invention;

FIG. 3C is a schematic plan view showing a modification of patterning in the electrostatic atomizer device according to the First Embodiment of the invention;

FIG. 3D is a schematic plan view showing a modification of patterning in the electrostatic atomizer device according to the First Embodiment of the invention;

FIG. 4 is a process flow diagram showing one example of a process for producing the electrostatic atomizer device according to the First Embodiment of the invention;

FIG. 5 is a process flow diagram showing another example of the process for producing the electrostatic atomizer device according to the First Embodiment of the invention;

FIG. 6 is a schematic side cross section view showing a characterizing portion of an electrostatic atomizer device according to Second Embodiment of the invention;

FIG. 7 is a schematic side cross section view showing a characterizing portion of an electrostatic atomizer device according to Third Embodiment of the invention;

FIG. 8A is a schematic side cross section view showing a characterizing portion of an electrostatic atomizer device according to Fourth Embodiment of the invention;

FIG. 8B is a schematic side cross section view showing the characterizing portion of the electrostatic atomizer device according to Fourth Embodiment of the invention;

FIG. 9 is a schematic side cross section view showing a characterizing portion of an electrostatic atomizer device according to Fifth Embodiment of the invention;

FIG. 10 is a schematic side cross section view showing a characterizing portion of an electrostatic atomizer device according to Sixth Embodiment of the invention; and

FIG. 11 is a schematic side cross section view showing a characterizing portion of a conventional electrostatic atomizer device.

### BEST MODE FOR CARRYING OUT THE INVENTION

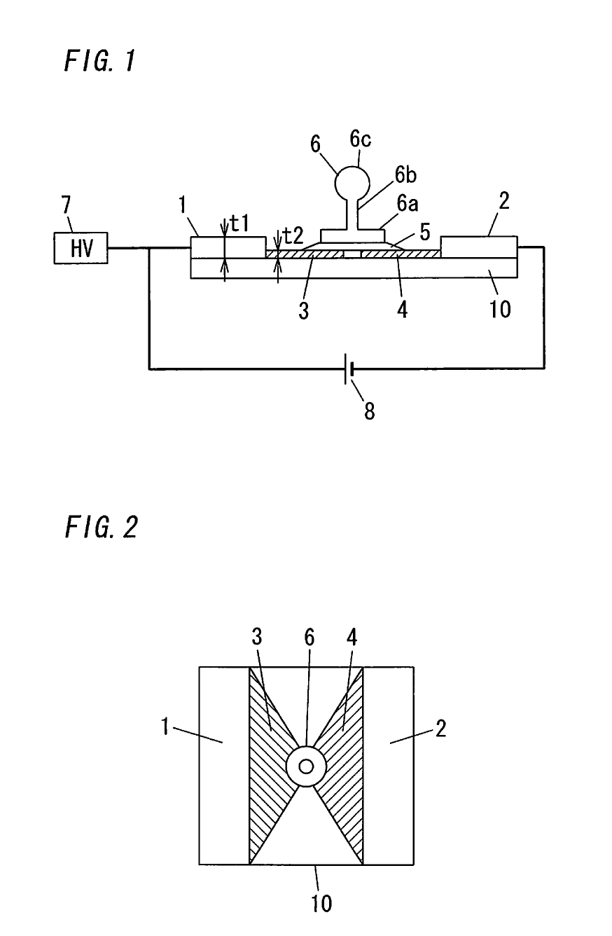

Hereinafter, First to Sixth Embodiments of the invention will be explained on the basis of FIGS. 1 to 10. Part of the constituent elements of the invention is similar to the publicly known constituent elements disclosed in the above-mentioned Japanese patent application publication No. 2011-25225 or the like. Therefore, the detailed explanation of such part will be omitted, and then the characteristic constituent elements of the invention will be explained below in detail.

### First Embodiment

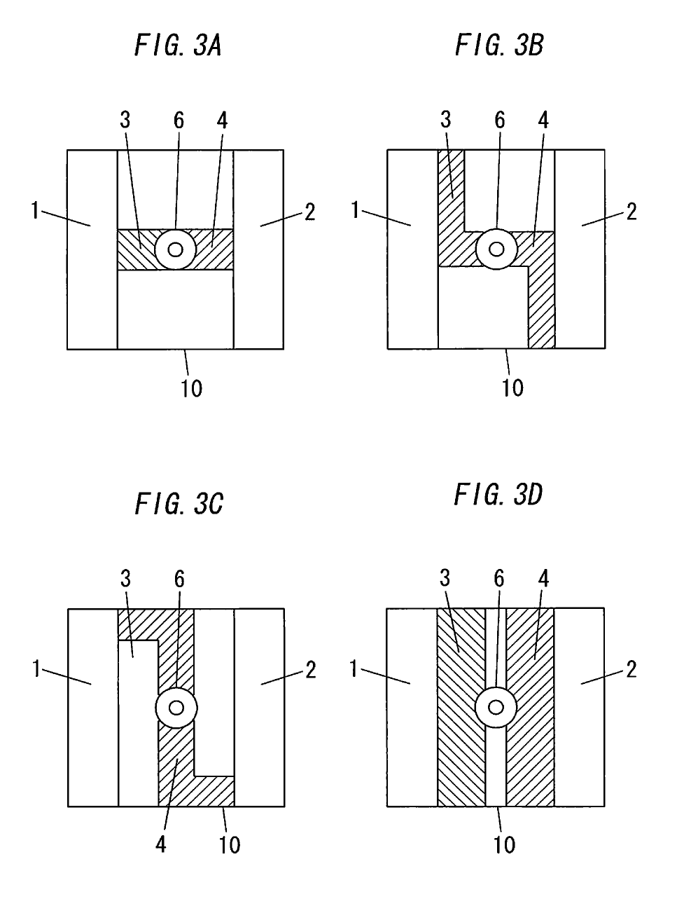

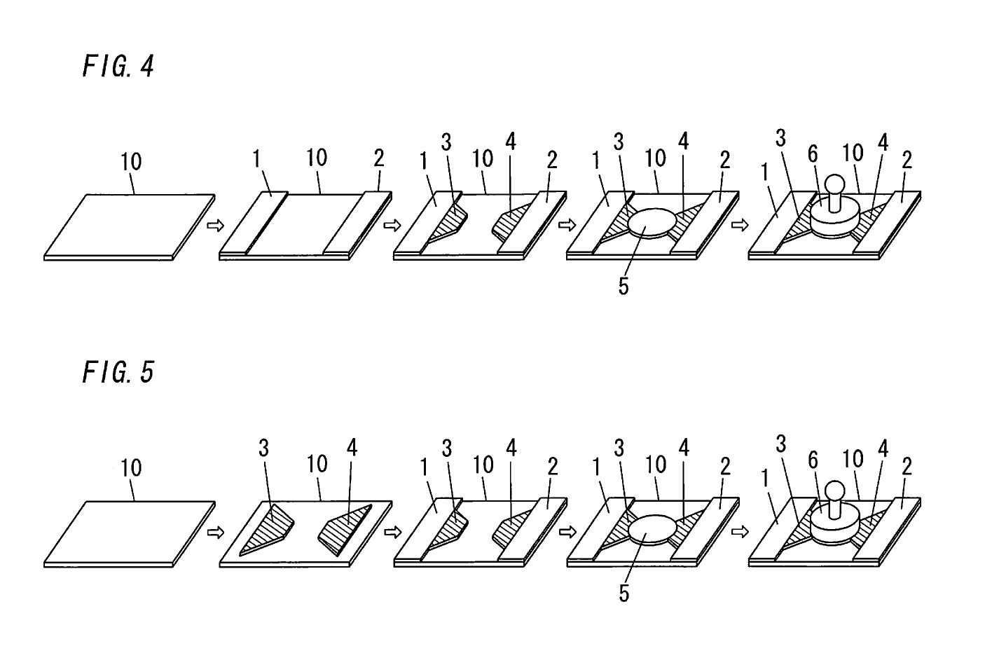

FIGS. 1 and 2 show schematically an electrostatic atomizer device according to First Embodiment of the invention. The electrostatic atomizer device according to the First Embodiment includes an N-type pattern 3 and a P-type pattern 4, and FIGS. 3A to 3D show the modifications of the N-type pattern 3 and P-type pattern 4. FIGS. 4 and 5 show processes for producing the electrostatic atomizer device according to the First Embodiment.

In the electrostatic atomizer device of the First Embodiment, a first heat radiation side electrode pattern 1, and a second heat radiation side electrode pattern 2, the N-type pattern 3 and the P-type pattern 4 are formed into thin-films on the same surface of a substrate 10. The N-type and P-type patterns 3, 4 are indicated with hatched lines in the Figures.

As the substrate 10, a general circuit substrate can be adopted. Specifically, examples of the substrate 10 include a glass epoxy substrate, a paper phenol substrate, a ceramic substrate such as alumina or aluminum nitride, a metal plate subjected to insulation coating treatment (e.g., an aluminum plate subjected to alumite treatment or a metal plate subjected to glass coating) and the like.

Examples of materials for the first and second heat radiation side electrode patterns 1, 2 include metals and the like (e.g., brass, aluminum and copper) that have superior electrical conductivity and heat conductivity. Each of the first and second heat radiation side electrode patterns 1, 2 is formed so as to have a film thickness t1 within substantively the range of 10 μm to 1 mm. Although not shown in the Figures, when a member for radiating heat, such as a radiation fin, is provided adjacently, sufficient space is provided between the member for radiating heat and each of the first and second heat radiation side electrode patterns 1, 2, or those are subjected to insulation coating, in order to secure insulation properties.

As a method for forming the first and second heat radiation side electrode patterns 1, 2, a general patterning method to the substrate 10 can be adopted. Specifically, evaporation or sputtering can be adopted, or an electrode plate that is thinly cut out may be fixed on the substrate 10 with an adhesive or the like, or a printing method may be used.

The first and second heat radiation side electrode patterns 1, 2 are respectively formed at both end edges on a surface of the substrate 10 formed into rectangle (See FIG. 2). The first heat radiation side electrode pattern 1 is formed at one end edge on the surface of the substrate 10, and more specifically, is formed into rectangle across the entire width of the one end edge. The second heat radiation side electrode pattern 2 is formed at the other end edge on the surface of the substrate 10, and then, is formed into rectangle across the entire width of the other end edge, as in the case of the first heat radiation side electrode pattern 1.

As a material for the N-type pattern 3, a general N-type thermoelectric material can be adopted. Also, as a material for the P-type pattern 4, a general P-type thermoelectric material can be adopted. Each of the N-type and P-type patterns 3, 4 is formed so as to have a film thickness t2 within substantively the range of 50 μm to 200 μm. The film thickness t2 of each of the N-type and P-type patterns 3, 4 is set smaller than the film thickness t1 of each of the first and second heat radiation side electrode patterns 1, 2.

Also, as a method for forming the N-type and P-type patterns 3, 4, a general patterning method to the substrate 10 can be adopted. Specifically, heating evaporation, ion beam evaporation, sputtering or the like can be adopted, or a method can be also adopted in which the printing and firing of the thermoelectric material are performed on the substrate 10, or a method can be also adopted in which a bulk material of the thermoelectric material thinly cut out is fixed on the substrate 10 with an adhesive or the like, or a method can be also adopted in which the melted thermoelectric material is poured into a groove provided on the substrate 10.

The N-type and P-type patterns 3, 4 are formed at a position between the first and second heat radiation side electrode patterns 1, 2, on the surface of the substrate 10. The N-type pattern 3 is formed on a half part of the surface side of the substrate 10 where the first heat radiation side electrode pattern 1 is formed, so as to be connected to the first heat radiation side electrode pattern 1. As shown in FIG. 2, the N-type pattern 3 is formed into a trapezoidal shape that has an upper base and a lower base. The lower base has a size across the entire width of the surface of the substrate 10. This lower base is connected to the first heat radiation side electrode pattern 1.

The P-type pattern 4 is formed on a half part of the surface side of the substrate 10 where the second heat radiation side electrode pattern 2 is formed, so as to be connected to the second heat radiation side electrode pattern 2. The P-type pattern 4 has the same size and shape as the N-type pattern 3 (that is, a trapezoidal shape that has an upper base and a lower base). The lower base of the P-type pattern 4 has a size across the entire width of the surface of the substrate 10. This lower base is connected to the second heat radiation side electrode pattern 2.

The patterning of the N-type and P-type patterns 3, 4 is performed on a central region of the surface of the substrate 10 so that the upper bases thereof (with small widths) are opposed to each other while an insulation space is maintained.

The electrostatic atomizer device of the present embodiment further includes an electrical jointing portion 5 that serves as a bridge between the N-type pattern 3 and the P-type pattern 4 on the surface of the substrate 10, and an emitter electrode 6 that is joined on the electrical jointing portion 5.

Examples of materials for the electrical jointing portion 5 include a solder, an electrically-conductive adhesive, a brazing filler metal and the like. In the case where the solder is used, a jointing part of the N-type pattern 3 and P-type pattern 4 is covered with Ni, Ni—Au or the like. The electrical jointing portion 5 is formed by coating so as to extend over both of: an end of the N-type pattern 3 that is positioned at the central region side of the surface of the substrate 10; and an end of the P-type pattern 4 that is positioned at the central region side of the surface of the substrate 10.

Examples of materials for the emitter electrode 6 include metal (brass, aluminum, copper, tungsten, titanium and the like), conductive resin, carbon and the like. Then, the emitter electrode 6 may be subjected to the surface treatment, such as gold or platinum, in order to improve corrosion resistance. The emitter electrode 6 includes a base section 6a, a pole section 6b that is provided so as to project from a center of a surface of the base section 6a, a spherical discharge section 6c that is formed at a tip of the pole section 6b. The electrical jointing portion 5 is joined to the reverse side of the base section 6a of the emitter electrode 6. In the case where the solder is used as the electrical jointing portion 5, when the material for the emitter electrode 6 is a metal that has difficulty in performing the solder jointing, the surface of the metal may be subjected to the nickel plating to make the solder jointing possible.

In the electrostatic atomizer device of the present embodiment with the above-mentioned configuration, the electrical connection between the N-type pattern 3 and the P-type pattern 4 is provided through the emitter electrode 6. Then, as explained above, the first and second heat radiation side electrode patterns 1, 2 are formed so as to be opposed to each other through the N-type pattern 3, the emitter electrode 6 and the P-type pattern 4, on the substrate 10. That is, the electrical conductive path for generating thermoelectric effect is formed by the connection of: the first heat radiation side electrode pattern 1; the N-type pattern 3; the emitter electrode 6; the P-type pattern 4; and the second heat radiation side electrode pattern 2 in that order that are located on one surface of the substrate 10.

The voltage application to the electrical conductive path is performed through using: a voltage application unit 7 that supplies a high voltage to the entire path; and an offset voltage application unit 8 that applies an offset voltage between the N-type and P-type patterns 3, 4 in the path. In this case, those voltage application units 7, 8 achieve both of making the emitter electrode 6 cool and applying the high voltage for causing the electrostatically atomization to the emitter electrode 6, through the conducting from the N-type pattern 3 to the P-type pattern 4.

As described above, according to the electrostatic atomizer device of the present embodiment, thermoelectric element pairs are formed into thin films as the N-type and P-type patterns 3, 4 on the substrate 10. Thus, it is possible to substantially reduce the size of the entire device in the upright direction, compared with the conventional electrostatic atomizer device shown in FIG. 11. Then, because the thin-film N-type and P-type patterns 3, 4 are adopted as the thermoelectric elements, the drive current is reduced and the electrical power saving for the entire device is enhanced.

Further, as described above, in the present embodiment, the film thickness t1 of each of the first and second heat radiation side electrode patterns 1, 2 is set larger than the film thickness t2 of each of the N-type and P-type patterns 3, 4 in order to improve the heat conductivity and the heat radiation of those heat radiation side electrode patterns 1, 2. For this reason, the electrostatic atomizer device of the present embodiment can improve the cooling performance for the emitter electrode 6 through the conducting between the N-type and P-type patterns 3, 4 and can enhance further the electrical power saving for the entire device.

In order to enhance further the cooling performance according to the Peltier effect, preferably, the substrate 10 is formed by using a material, such as alumina or aluminum nitride, that has higher heat conductivity than each of the N-type and P-type patterns 3, 4. Therefore, the substrate 10 itself functions as a radiator plate, and the cooling performance is enhanced.

FIGS. 3A to 3D show modifications of pattern shapes for the N-type and P-type patterns 3, 4. With respect to the respective pattern shapes for the N-type and P-type patterns 3, 4, there is no specific restriction except for the installation of parts for the conduction inputs. Therefore, the pattern shapes as shown in FIGS. 3A to 3D can be also adopted. Here, in the electrostatic atomizer device of the present embodiment, each of the N-type and P-type patterns 3, 4 is formed into a specific shape (such as trapezoidal shape or a fan shape) so that a width thereof diminishes toward a part thereof electrically connected to the emitter electrode 6. In this case, it is possible to make the heat absorptive action concentrate on the emitter electrode 6, while keeping the heat conductivity of the entire N-type and P-type patterns 3, 4. For this reason, according to the pattern shape as shown in FIG. 2, it is possible to improve the cooling performance for the emitter electrode 6, and to enhance the electrical power saving for the entire device.

FIG. 4 shows one example of a process for producing the electrostatic atomizer device according to the present embodiment. In this example, first, the thin-film first and second heat radiation side electrode patterns 1, 2 are respectively formed at both ends on one surface of the substrate 10. Next, the trapezoidal-shaped N-type pattern 3 is formed so that the lower base thereof is connected to the first heat radiation side electrode pattern 1, on the one surface of the substrate 10, and similarly, the trapezoidal-shaped P-type pattern 4 is formed so that the lower base thereof is connected to the second heat radiation side electrode pattern 2, on the one surface of the substrate 10. At this time, the N-type and P-type patterns 3, 4 are formed so that the upper bases thereof are opposed to each other at a distance.

The electrical jointing portion 5, such as an electrically-conducting adhesive, is then applied to the center of the substrate 10 so as to serve as a bridge between the upper bases of the N-type and the P-type patterns 3, 4. The emitter electrode 6 is then installed on the electrical jointing portion 5, and the base section 6a of the emitter electrode 6 is joined to the electrical jointing portion 5.

FIG. 5 shows another example of the process for producing the electrostatic atomizer device. This example is different from one example in FIG. 4 in that the order of the process for forming the first and second heat radiation side electrode patterns 1, 2 on the substrate 10 is exchanged with the order of the process for forming the N-type and the P-type patterns 3, 4 on the substrate 10.

That is, in this example shown in FIG. 5, first, the N-type and the P-type patterns 3, 4 are formed into trapezoidal shapes on one surface of the substrate 10. At this time, the patterning is performed so that the upper bases of the N-type and the P-type patterns 3, 4 are opposed to each other at a distance. Next, the patterning of the first heat radiation side electrode pattern 1 that is connected to the lower base of the N-type pattern 3 and the patterning of the second heat radiation side electrode pattern 2 that is connected to the lower base of the P-type pattern 4 are performed to the respective ends on the surface of the substrate 10. Processes that follow are the same as those of the example shown in FIG. 4.

### Second Embodiment

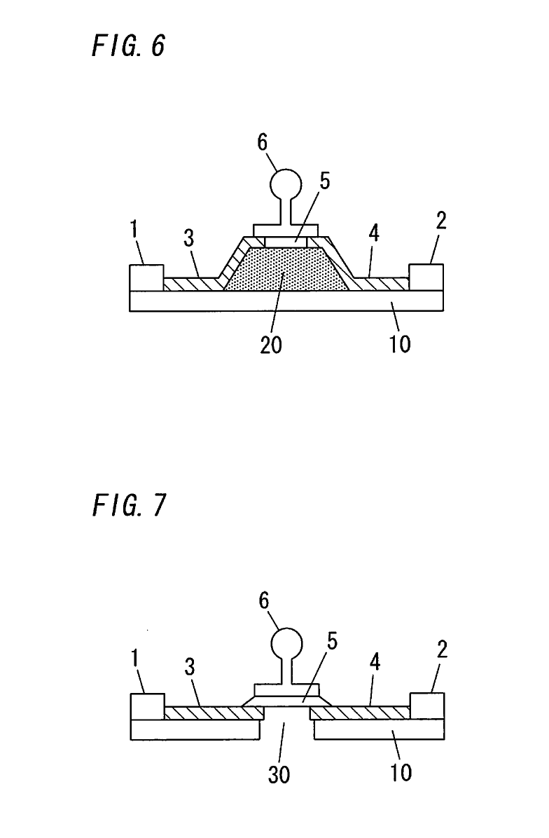

FIG. 6 shows schematically a characterizing portion of an electrostatic atomizer device according to Second Embodiment of the invention. The electrostatic atomizer device according to the present embodiment will be explained below, but the detailed explanation of the constituent elements similar to the First Embodiment will be omitted.

As shown in FIG. 6, in the present embodiment, the electrostatic atomizer device further includes a low-heat conduction portion 20 that is installed on the one surface of the substrate 10. As the low-heat conduction portion 20, a member that has lower heat conductivity than the substrate 10 is adopted, and more preferably, a heat insulation material is adopted. In the production process, the process for forming the low-heat conduction portion 20 on the substrate 10 is performed before the process for forming the N-type and P-type patterns 3, 4 on the substrate 10.

The N-type and P-type patterns 3, 4 are deposited so that the ends of the cooling sides thereof (half parts of the cooling sides in the example shown in the Figure) are mounted on the low-heat conduction portion 20. The N-type and P-type patterns 3, 4 are formed by patterning so the ends of the cooling sides thereof are opposed to each other on the low-heat conduction portion 20. Those ends of the N-type and P-type patterns 3, 4 are connected to the emitter electrode 6 via the electrical jointing portion 5.

In the present embodiment, the low-heat conduction portion 20 located between the emitter electrode 6 and the substrate 10 can prevent the heat from leaking from outside to the emitter electrode 6 and the ends of the cooling sides of the N-type and P-type patterns 3, 4 through the substrate 10. Therefore, it is possible to improve the cooling efficiency for the emitter electrode 6.

Also in the present embodiment, preferably, the substrate 10 is formed by using a material (such as an alumina substrate or an aluminum nitride substrate) that has higher heat conductivity than each of the N-type and P-type patterns 3, 4. For this reason, the electrostatic atomizer device can effectively radiate heat through the substrate 10, while reducing the heat leaked from outside to the emitter electrode 6 and the ends of the cooling sides through the substrate 10.

### Third Embodiment

FIG. 7 shows schematically a characterizing portion of an electrostatic atomizer device according to Third Embodiment of the invention. The electrostatic atomizer device according to the present embodiment will be explained below, but the detailed explanation of the constituent elements similar to the First Embodiment will be omitted.

As shown in FIG. 7, in the present embodiment, the electrostatic atomizer device further includes a through portion 30 for preventing heat leakage that is provided at a part of the substrate 10 adjacent to the emitter electrode 6. The through portion 30 is formed by making a through-hole at a part of the substrate 10 that is located immediately below the emitter electrode 6 (that is, at a part of the substrate 10 that is opposed to the base section 6a of the emitter electrode 6).

The N-type and P-type patterns 3, 4 are formed so that the ends of the cooling sides thereof extend to the periphery of the through portion 30 or adjacent to the periphery. The through portion 30 is communicated with an insulation space formed between the ends of the cooling sides of the N-type and P-type patterns 3, 4. The ends of the cooling sides of the N-type and P-type patterns 3, 4 are connected to emitter electrode 6 via the electrical jointing portion 5 that serves as a bridge between the ends.

For this reason, in the present embodiment, the through portion 30 functions as a series of a heat-insulating layer together with the insulation space, thereby preventing the heat from leaking from outside to the emitter electrode 6 through the substrate 10. Therefore, it is possible to improve the cooling efficiency for the emitter electrode 6.

Also in the present embodiment, preferably, the substrate 10 is formed by using a material (such as an alumina substrate or an aluminum nitride substrate) that has higher heat conductivity than each of the N-type and P-type patterns 3, 4. For this reason, the electrostatic atomizer device can effectively radiate heat through the substrate 10, while reducing the heat leaked from outside to the emitter electrode 6 and the ends of the cooling sides through the substrate 10.

Although not shown in Figures, a thin-wall portion may be provided at the center of the substrate 10, instead of the through portion 30. The thin-wall portion can be formed so as to have an appropriate thickness by providing a depression as an excavated hole at the substrate 10. The heat leakage with respect to the emitter electrode 6 can be reduced by providing such a thin-wall portion.

### Fourth Embodiment

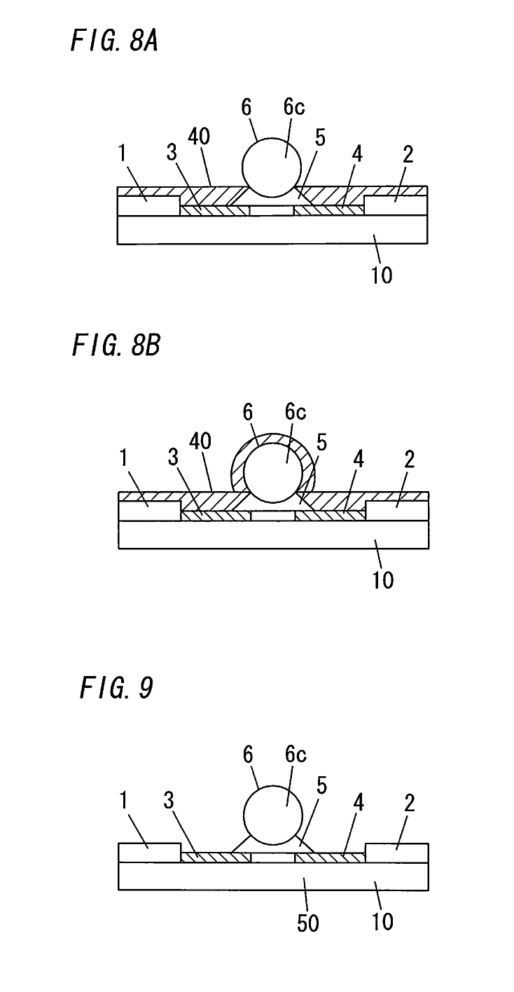

FIGS. 8A and 8B show schematically a characterizing portion of an electrostatic atomizer device according to Fourth Embodiment of the invention. The electrostatic atomizer device according to the present embodiment will be explained below, but the detailed explanation of the constituent elements similar to the First Embodiment will be omitted.

As shown in FIGS. 8A and 8B, in the present embodiment, the emitter electrode 6 is configured by only the spherical discharge section 6c in order to further reduce the size of the entire device in the upright direction. Then, one surface side of the substrate 10 at which the emitter electrode 6 and the like are located is covered with a waterproof coating material 40. The waterproof coating material 40 shown in FIG. 8A covers the entire one surface of the substrate 10 except for the emitter electrode 6. The waterproof coating material 40 shown in FIG. 8B covers the entire one surface of the substrate 10 so as to include the emitter electrode 6. A part of the waterproof coating material 40 that covers the emitter electrode 6 (that is, the discharge section 6c) is provided so as to have a thickness to cause the electrostatically atomization with respect to the condensation water on the surface of the part.

The process for making the waterproof coating material 40 on one surface of the substrate 10 is performed after all of the processes described in the First Embodiment (that is, after the process for joining the emitter electrode 6 to the electrical jointing portion 5).

In this way, all or part of the electrical conductive path formed on one surface of the substrate 10 is covered with the waterproof coating material 40. Therefore, it is possible to prevent the migration and corrosion that are caused by adherence of the condensation water to the electrical conductive path on the substrate 10. Of course, the waterproof coating material 40 can be also adopted for the electrostatic atomizer device with the emitter electrode 6 formed into the shape as the First Embodiment.

### Fifth Embodiment

FIG. 9 shows schematically a characterizing portion of an electrostatic atomizer device according to Fifth Embodiment of the invention. The electrostatic atomizer device according to the present embodiment will be explained below, but the detailed explanation of the constituent elements similar to the First Embodiment will be omitted.

As shown in FIG. 9, in the present embodiment, the emitter electrode 6 is configured by only the spherical discharge section 6c in order to further reduce the size of the entire device in the upright direction, like the Fourth Embodiment. Further, the substrate 10 is formed as a porous body 50 so that the surplus of the condensation water is absorbed from one surface side of the substrate 10.

The surplus of the condensation water is absorbed into the substrate 10. As a result, water more than needs is hardly supplied to the discharge section 6c of the emitter electrode 6, and it is possible to stably generate the electrically atomizing phenomenon. The water absorbed into the substrate 10 is heated through the heat radiation sides of the N-type and the P-type patterns 3, 4 and the first and second heat radiation side electrode patterns 1, 2, and then is vaporized to outside air. At this time, by heat of vaporization, the heat radiation is effectively performed through the substrate 10, and the cooling efficiency for the emitter electrode 6 is improved. That is, it is possible to improve both of the stability of the electrostatically atomization generated at the emitter electrode 6 and the cooling efficiency for the emitter electrode 6, by adopting the substrate 10 with porous.

### Sixth Embodiment

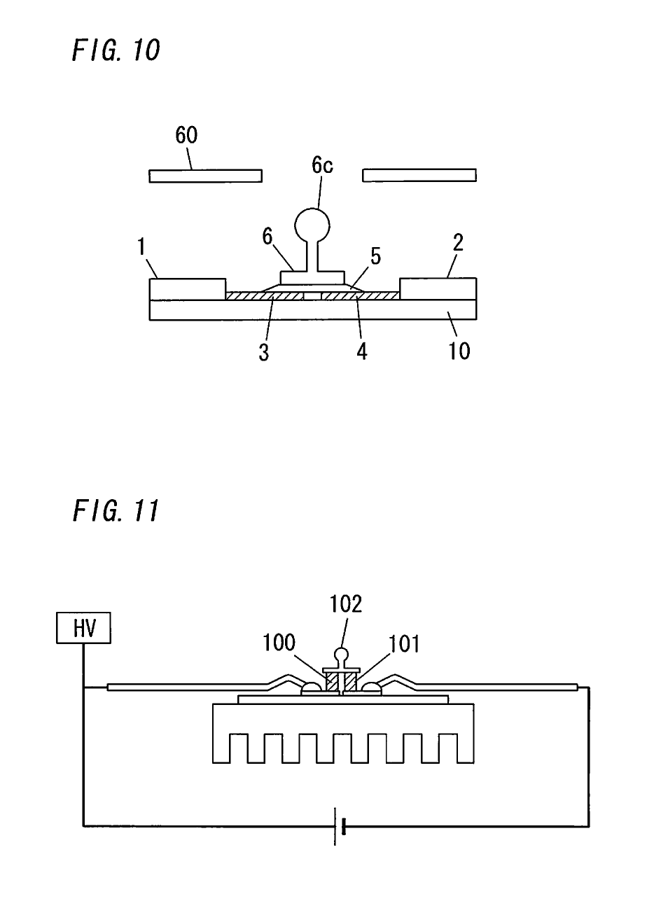

FIG. 10 shows schematically a characterizing portion of an electrostatic atomizer device according to Sixth Embodiment of the invention. The electrostatic atomizer device according to the present embodiment will be explained below, but the detailed explanation of the constituent elements similar to the First Embodiment will be omitted.

As shown in FIG. 10, in the present embodiment, the electrostatic atomizer device further includes an opposed electrode 60 that is located at a position opposed to the discharge section 6c of the emitter electrode 6. The opposed electrode 60 is formed of metal (such as SUS, copper or platinum) or conductive resin, or the opposed electrode 60 is formed by performing the patterning of an electrode, using a conducting material to resin. In order to improve corrosion resistance, the coating of a material with high-corrosion resistance (such as gold or platinum) may be further performed.

The opposed electrode 60 shown in the Figure is formed by making a through-hole at the center of a flat plate. Here, as long as it is possible to stabilize the electrostatically atomization, the opposed electrode 60 with a dome-shape or the like can be also adopted suitably.

Although not shown in Figures, the electrostatic atomizer device may further include a mounting base for holding the opposed electrode 60 that is fixed at the substrate 10 side, in order to keep the opposed electrode 60 at a predetermined position, or the opposed electrode 60 may be located at the equipment side that is provided with the electrostatic atomizer device. In the case where the opposed electrode 60 is located at the equipment side, the mounting base is not required at the electrostatic atomizer device side and it is possible to achieve reduction in size and weight of the entire device.

The opposed electrode 60 may be electrically grounded, or the electrostatic atomizer device may have the configuration that applies high voltage to the opposed electrode 60. However, because the above-mentioned Japanese patent application publication No. 2011-25225 discloses how voltage is applied in the case where the opposed electrode is provided, the detailed explanation thereof will be omitted in the present specification.

As explained above based on the basis of FIGS. 1 to 10, each of the electrostatic atomizer devices according to the First to Sixth Embodiments of the invention includes: a substrate 10; a thin-film N-type pattern 3 formed on the substrate 10, using an N-type thermoelectric material; a thin-film P-type pattern 4 formed on the substrate 10, using a P-type thermoelectric material; and an emitter electrode 6 connected between the N-type pattern 3 and the P-type pattern 4. The N-type pattern 3, the emitter electrode 6 and the P-type pattern 4 form an electrical conductive path.

In this way, P-type and N-type thermoelectric elements are formed as the thin-film patterns on the substrate 10 and the emitter electrode 6 is located so as to be mounted to the thin-film patterns formed on the substrate 10. As a result, it is possible to substantially reduce the size of the entire device in the upright direction. Therefore, it is possible to easily install the electrostatic atomizer device in a small mobile device for example. In addition, because the P-type and N-type thermoelectric elements are formed as the thin-film patterns on the substrate 10, the drive current is also reduced. For this reason, it is possible to easily install the electrostatic atomizer device also in a device that is driven by a battery.

Each of the electrostatic atomizer devices according to the First to Sixth Embodiments of the invention further includes a thin-film first heat radiation side electrode pattern 1 and a thin-film second heat radiation side electrode pattern 2, both of which being formed on the substrate 10. The first and second heat radiation side electrode patterns 1, 2 are formed so as to be opposed to each other through the N-type pattern 3, the emitter electrode 6 and the P-type pattern 4, on the substrate 10. The first heat radiation side electrode pattern 1, the N-type pattern 3, the emitter electrode 6, the P-type pattern 4 and the second heat radiation side electrode pattern 2 form the electrical conductive path. The first heat radiation side electrode pattern 1 is formed so as to have a thickness larger than each of the N-type and P-type patterns 3, 4, and the second heat radiation side electrode pattern 2 is formed so as to have a thickness larger than each of the N-type and P-type patterns 3, 4.

In this way, it is possible to form: a part that doubles as both of an electrode and a heat radiation unit (the first and second heat radiation side electrode patterns 1, 2); and the P-type and N-type thermoelectric elements (the N-type and P-type patterns 3, 4), as the thin-film patterns on the substrate 10. Therefore, the entire device is further downsized and it becomes easy to manufacture the device. Further, the first and second heat radiation side electrode patterns 1, 2 of the patterns on the substrate 10 are provided so as to have relatively large thicknesses in order to secure the heat conductivity and the heat radiation, and therefore, it is also possible to improve the cooling efficiency for the emitter electrode 6.

Each of the electrostatic atomizer devices according to the First to Sixth Embodiments of the invention further includes an electrical jointing portion 5 that serves as a bridge between the N-type pattern 3 and the P-type pattern 4. The emitter electrode 6 is joined on the electrical jointing portion 5.

In this way, because the emitter electrode 6 is joined on the electrical jointing portion 5, the N-type pattern 3, the P-type pattern 4 and the emitter electrode 6 are connected electrically and mechanically, and further the entire device is also downsized.

In each of the electrostatic atomizer devices according to the First to Sixth Embodiments of the invention, preferably, the substrate 10 is formed of a material that has higher heat conductivity than each of the N-type 3 and P-type patterns 4.

In this way, because the substrate 10 with high heat conductivity is adopted, it is possible to make the substrate 10 itself function as a heat radiation unit, and to improve the cooling efficiency for the emitter electrode 6.

The electrostatic atomizer device according to the Second Embodiment of the invention further includes a low-heat conduction portion 20 that has lower heat conductivity than the material for the substrate 10. The low-heat conduction portion 20 is located between the substrate 10 and the emitter electrode 6.

In this way, because the low-heat conduction portion 20 is located, it is possible to prevent heat from leaking between the emitter electrode 6 and the substrate 10, and to improve the cooling efficiency for the emitter electrode 6.

The electrostatic atomizer device according to the Third Embodiment of the invention further includes a through portion 30 or a thin-wall portion for preventing heat leakage. The through portion 30 or the thin-wall portion is provided at a part of the substrate 10 adjacent to the emitter electrode 6.

In this way, because the through portion 30 or the thin-wall portion is provided at the substrate 10, it is possible to prevent heat from leaking between the emitter electrode 6 and the substrate 10, and to improve the cooling efficiency for the emitter electrode 6.

In each of the electrostatic atomizer devices according to the First to Sixth Embodiments of the invention, each of the N-type and P-type patterns 3, 4 is formed so that a width thereof diminishes toward a part thereof electrically connected to the emitter electrode 6.

In this way, because the patterning is performed so that each of the N-type and P-type patterns 3, 4 has such a shape in planar view, it is possible to make the heat absorptive action concentrate on the emitter electrode 6, while keeping the heat conductivity of the entire N-type and P-type patterns 3, 4. For this reason, it is possible to improve the cooling efficiency for the emitter electrode 6.

In the electrostatic atomizer device according to the Fourth Embodiment of the invention, all or part of the electrical conductive path on the substrate 10 is covered with a waterproof coating material 40.

For this reason, it is possible to prevent the migration and corrosion that are caused by adherence of water generated by the condensation and the like to the electrical conductive path on the substrate 10.

In the electrostatic atomizer device according to the Fifth Embodiment of the invention, the substrate 10 is formed as a porous body 50.

For this reason, the surplus of water generated by the condensation and the like is absorbed into the substrate 10 formed as the porous body 50. Then, the water absorbed into the porous body 50 is vaporized by heating, thereby improving the heat radiation performance through the substrate 10. That is, because the surplus of the water is absorbed by adopting the porous body 50 as the substrate 10, it is possible to improve both of the stability of the electrostatically atomization and the cooling efficiency for the emitter electrode 6.

The electrostatic atomizer device according to the Sixth Embodiment of the invention further includes an opposed electrode 60 that is located at a position opposed to the emitter electrode 6.

For this reason, it is possible to stably generate the electrostatically atomization at the emitter electrode 6, and further it is possible to powerfully emit the generated charged minute water particles toward a predetermined direction.

A method for producing any one of the electrostatic atomizer devices according to the First to Sixth Embodiments of the invention includes the steps of: forming a thin-film N-type pattern 3 on a substrate 10, using an N-type thermoelectric material; forming a thin-film P-type pattern 4 on the substrate 10, using a P-type thermoelectric material; forming an electrical jointing portion 5 that serves as a bridge between the N-type pattern 3 and the P-type pattern 4; and joining an emitter electrode 6 on the electrical jointing portion 5.

In this way, because P-type and N-type thermoelectric elements are formed as the thin-film patterns on the substrate 10 and the emitter electrode 6 is mounted on the thin-film patterns through the electrical jointing portion 5, it is possible to produce the electrostatic atomizer device in which the size thereof in the upright direction is substantially reduced. Also, it is possible to easily install the electrostatic atomizer device in a small mobile device for example. In addition, the drive current in the electrostatic atomizer device is also reduced, and it is possible to easily install the electrostatic atomizer device also in a small mobile device that is driven by a battery.

The method for producing any one of the electrostatic atomizer devices according to the First to Sixth Embodiments of the invention further includes a step of forming a thin-film first heat radiation side electrode pattern 1 and a thin-film second heat radiation side electrode pattern 2 so as to be opposed to each other through the N-type pattern 3, the emitter electrode 6 and the P-type pattern 4, on the substrate 10.

In this way, it is possible to form: a part that doubles as both of an electrode and a heat radiation unit (the first and second heat radiation side electrode patterns 1, 2); and the N-type and P-type patterns 3, 4, as the thin-film patterns on the substrate 10. Therefore, it is possible to produce the electrostatic atomizer device downsized further, and also it becomes easy to produce the electrostatic atomizer device.

Although the present invention has been described above based on some embodiments shown in attached Figures, the present invention is not limited to those embodiments. In each of those embodiments, the numerous modifications and variations can be made by those skilled in the art without departing from the true spirit and scope of this invention, namely claims (For example, the respective electrostatic atomizer devices according to the First to Fifth Embodiments may be also provided with opposed electrodes 60).

1. An electrostatic atomizer device, comprising:
a substrate;
a thin-film N-type pattern formed on the substrate, using an N-type thermoelectric material;
a thin-film P-type pattern formed on the substrate, using a P-type thermoelectric material; and
an emitter electrode connected between the N-type pattern and the P-type pattern,
the N-type pattern, the emitter electrode and the P-type pattern forming an electrical conductive path.

2. The electrostatic atomizer device according to claim 1, further comprising a thin-film first heat radiation side electrode pattern and a thin-film second heat radiation side electrode pattern, both of which being formed on the substrate,
wherein the first and second heat radiation side electrode patterns are formed so as to be opposed to each other through the N-type pattern, the emitter electrode and the P-type pattern, on the substrate,
the first heat radiation side electrode pattern, the N-type pattern, the emitter electrode, the P-type pattern and the second heat radiation side electrode pattern forming the electrical conductive path,
the first heat radiation side electrode pattern being formed so as to have a thickness larger than each of the N-type and P-type patterns, the second heat radiation side electrode pattern being formed so as to have a thickness larger than each of the N-type and P-type patterns.

3. The electrostatic atomizer device according to claim 1, further comprising an electrical jointing portion that serves as a bridge between the N-type pattern and the P-type pattern, the emitter electrode being joined on the electrical jointing portion.

4. The electrostatic atomizer device according to claim 1, wherein the substrate is formed of a material that has higher heat conductivity than each of the N-type and P-type patterns.

5. The electrostatic atomizer device according to claim 1, further comprising a low-heat conduction portion that has lower heat conductivity than the material for the substrate, the low-heat conduction portion being located between the substrate and the emitter electrode.

6. The electrostatic atomizer device according to claim 1, further comprising a through portion or a thin-wall portion for preventing heat leakage, the through portion or the thin-wall portion being provided at a part of the substrate adjacent to the emitter electrode.

7. The electrostatic atomizer device according to claim 1, wherein each of the N-type and P-type patterns is formed so that a width thereof diminishes toward a part thereof electrically connected to the emitter electrode.

8. The electrostatic atomizer device according to claim 1, wherein all or part of the electrical conductive path on the substrate is covered with a waterproof coating material.

9. The electrostatic atomizer device according to claim 1, wherein the substrate is formed as a porous body.

10. The electrostatic atomizer device according to claim 1, further comprising an opposed electrode that is located at a position opposed to the emitter electrode.

11. A method for producing an electrostatic atomizer device, comprising the steps of:
forming a thin-film N-type pattern on a substrate, using an N-type thermoelectric material;
forming a thin-film P-type pattern on the substrate, using a P-type thermoelectric material;
forming an electrical jointing portion that serves as a bridge between the N-type pattern and the P-type pattern; and
joining an emitter electrode on the electrical jointing portion.

12. The method for producing the electrostatic atomizer device according to claim 11, further comprising a step of forming a thin-film first heat radiation side electrode pattern and a thin-film second heat radiation side electrode pattern so as to be opposed to each other through the N-type pattern, the emitter electrode and the P-type pattern, on the substrate.
